(19) United States
(12) Patent Application Publication
(10) Pub. No.: US 2002/0142667 A1
(43) Pub. Date: Oct. 3, 2002

(54) Interchangeable connector jack

(76) Inventors: David L. Reed, Fountaintown, IN (US); Paul J. Straub JR., Mooresville, IN (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/821,125

(22) Filed: Mar. 29, 2001

(51) Int. Cl. H01R 24/00

(52) U.S. Cl. 439/676

(57) ABSTRACT

A multi-contact connector jack is interchangeable with mating plugs having an equal number of contacts for forming a high performance connector and with plugs having a lesser number of contacts without damage to the jack. The jack has a plurality of rear cantilevered spring wires arranged in a linear array for mating with contact blades in the plug, wherein at least the two end positioned spring wires have a plug contact region followed by a depressed region wherein the plug nose of a plug of fewer contacts ceases to depress the spring wires to an extreme degree, thereby preserving the resilience of the spring wires.

### FIELD OF THE INVENTION

This invention relates to an electrical connector comprising a plug and jack modular arrangement and, more particularly, to a multi-purpose interchangeable jack for use therein.

### BACKGROUND OF THE INVENTION

Modern communication needs have grown to the point that multiple communication outlets frequently need to be located in close proximity, at the same customer premises, in order to service multiple devices including modems, telephones and facsimile machines. It is undesirable to clutter a wall with many individual outlets, each serving a separate device. Furthermore, when multiple outlets are brought together within the same apparatus, it is generally quite difficult to make the needed wiring connections in a convenient manner. Imagine, for example, a conventional wall plate (typically 2¾×4½ inches) having six communication outlets, and each outlet having eight wires. Combining known communication outlets would require a substantially larger wall plate and/or lead to an uncontrolled maze of wires where the premises wiring is connected.

Efforts to alleviate the situation involving a multiplicity specialized connectors have led to a variety of solutions. U.S. Pat. No. 4,261,633 discloses a wiring module for telephone jack for use in connection with a wall plate. The wiring module includes a metallic lead frame having a plurality of conductors that function as spring contacts, at one end of the lead frame, after insertion into an associated jack frame. Free-standing, electrical connecting terminals are connected to the conductors at the other end of the lead frame. The conductors of the lead frame fan out as they extend toward the connecting terminals. Nevertheless, these terminals are so close together that considerable dexterity is required for making connections by hand. Furthermore, although this wiring module achieves a degree of compactness, it appears that the associated wall plate can accept a maximum of only two modular jacks before a second wall plate is required.

U.S. Pat. No. 4,865,564 discloses a wall mounted connecting block in which the conductors of a metallic lead frame are shaped as insulation-displacing connectors, at one end of the lead frame, and function as connecting terminals to facilitate making electrical connections by hand. The entire assembly is suited for wall mounting; but unfortunately, a single modular jack fills the entire available space of a conventional wall outlet.

The plug and jack arrangement which is the most favored comprises a plug having, for example, six or eight contacts, and a jack comprising a spring block and housing and having, usually, six or eight cantilevered spring contacts. When the plug is inserted into the jack, the spring contacts are contacted and bent slightly by the plug contacts, and the spring force is exerted at the junction to insure good electrical contact. It is usually the case, when the number of spring contacts is the same as the number of plug contacts, that at least two connectors are required when one plug connected to equipment has six contacts and one plug has eight contacts; however, the necessity for two connectors can be obviated by the use of a single eight contact jack into which either a six contact or an eight contact plug may be inserted. Thus, if a connector is used with a telephone, both plug and jack have eight contacts. On the other hand, if the connector is used with some other type apparatus (fax machine, computer, etc.) requiring a six contact plug, then the plug has six contacts but the jack has eight. With proper wiring of the jack, this latter arrangement works in a normal manner. However, the versatility of the jack is impaired by metal fatigue in the spring contacts, which occurs after long usage of the eight spring jack as a six contact plug receptacle.

Most recently, there has been a re-design of modular jacks to meet more demanding electrical performance needs, primarily for accommodating ever increasing bandwidth data communications. In U.S. Pat. No. 6,116,964, issued Sep. 12, 2000, of Goodrich et al., the disclosure of which is incorporated herein by reference, there is disclosed a jack design which is gaining widespread use, wherein the spring contacts are cantilevered from the rear of the jack instead of from the front as in older, lower performance jacks. The following discussion is directed to such a jack.

When an eight position plug is inserted into an eight position rear cantilevered jack, all eight contact springs are engaged by the eight plug contacts. However, when a six contact plug is inserted into an eight position jack, the outermost contacts 1 and 8 are deflected not by the plug contacts, but by the nose of the plug housing, as discussed hereinbefore. Because of the unique configuration of the rear cantilevered spring contacts of the high performance jack, this deflection of contacts 1 and 8 is undesirably large and can lead to the aforementioned problem of sufficient spring distortion or metal fatigue to prevent the spring contact from regaining its original position and shape when the plug is removed. Thus, if an eight position plug is thereafter inserted in the jack, contact in positions 1 and 8 will not occur, leading to subsequent malfunction of the associated circuitry and components connected thereto. It can be seen therefore, that a return to the undesirable multiple connector use represents the solution to the problem, with the attendant multiplicity of outlets, each serving a separate device.

### SUMMARY OF THE INVENTION

The present invention is a connector jack in which the configuration of the jack spring contacts is modified to minimize the amount of spring deflection caused by the plug housing where the plug has fewer contact positions than does the housing. In particular, each spring contact has, in one embodiment of the invention, a depressed region forming a roughly S-shaped bend in the region of the spring where contact takes place. As will be seen more clearly hereinafter, the extent of deflection of the spring by the plug housing is materially reduced with a consequent preservation of its spring resilience so that, upon removal of the plug, it returns to its original pre-contact position.

In alternative embodiments of the invention, shapes other than an S may be used to reduce the deflection of the spring contact by the plug, but in all of the embodiments the basic principle of reducing spring deflection is preserved and maintained by means of a depressed portion in the contact region of the plug and spring.

This and other principles and features of the present invention will be more readily apparent from the following detailed description read in conjunction with the accompanying drawings.

### DESCRIPTION OF THE DRAWINGS

FIG. 1 is a perspective view of a component of station hardware connected to a cable by means of a plug and jack connector;

FIG. 2 is a diagrammatic view of the front of a connector jack illustrating the contact assignment therein;

FIG. 3 is an exploded perspective view of a high performance jack to which the present invention is applicable;

FIG. 4 is a diagrammatic view in side elevation of a plug mated with the jack of FIG. 3 to form a connector;

FIGS. 5a and 5b are diagrammatic views of the mating process of FIG. 4;

FIGS. 6a and 6b are diagrammatic views of the mating arrangement of FIGS. 5a and 5b, illustrating the problem to which the present invention is directed;

FIGS. 7a and 7b are first and second embodiments of spring wire contacts embodying the principles and features of the present invention;

FIGS. 8a and 8b depict the mating of a plug with a jack having the spring wire contacts of the present invention; and

FIG. 9 depicts an alternative embodiment of the jack of the present invention.

### DETAILED DESCRIPTION

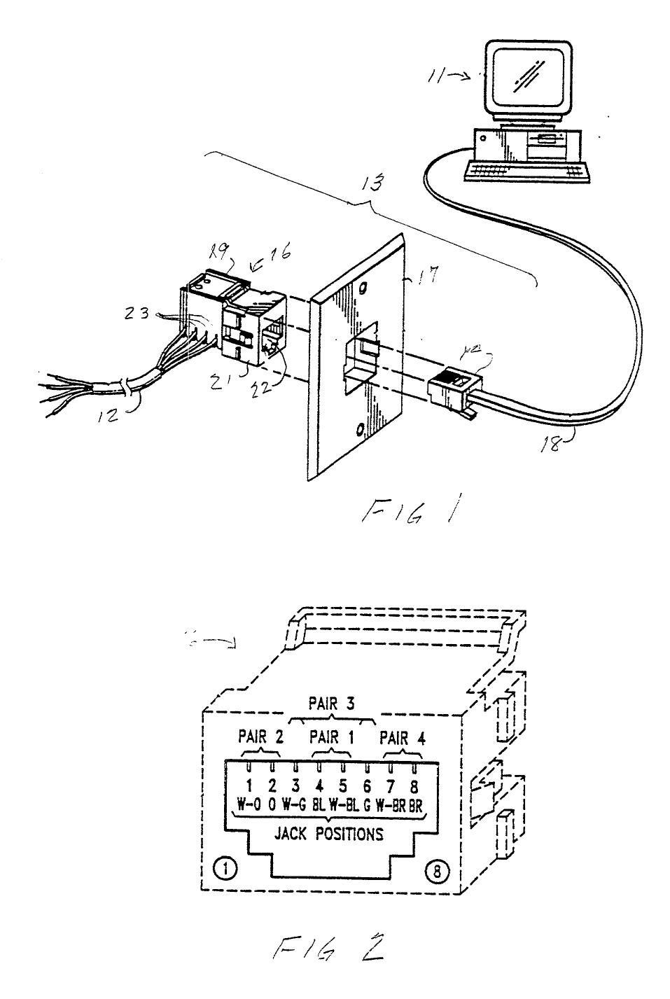

In FIG. 1 there is shown an interconnection between high speed station hardware 11 and a cable 12 which comprises a number of wire pairs. The electrical connection is made through a standard telecommunications connector assembly 13 comprising a modular plug 14 and modular jack 16 which is shown mounted to a wall plate 17. Plug 14 terminates a cable 18 which is connected to the hardware 11. Specifications for such plugs and jacks can be found in subpart F of the FCC part 68.500 Registration Rules. Jack 16 comprises a connector member 19 and jack frame 21 which are locked together and with wall plate 17 to form a receptacle for modular plug 14, which, to make the connection, is inserted into opening 22 in jack frame 21 where it makes contact with contact springs which form part of connector member 19, as will be discussed more fully hereinafter. Connector member 19 is shown connected to cable 12 by means of a plurality of insulation displacement connectors 23 which are internally connected to the jack springs (not shown) within jack 16.

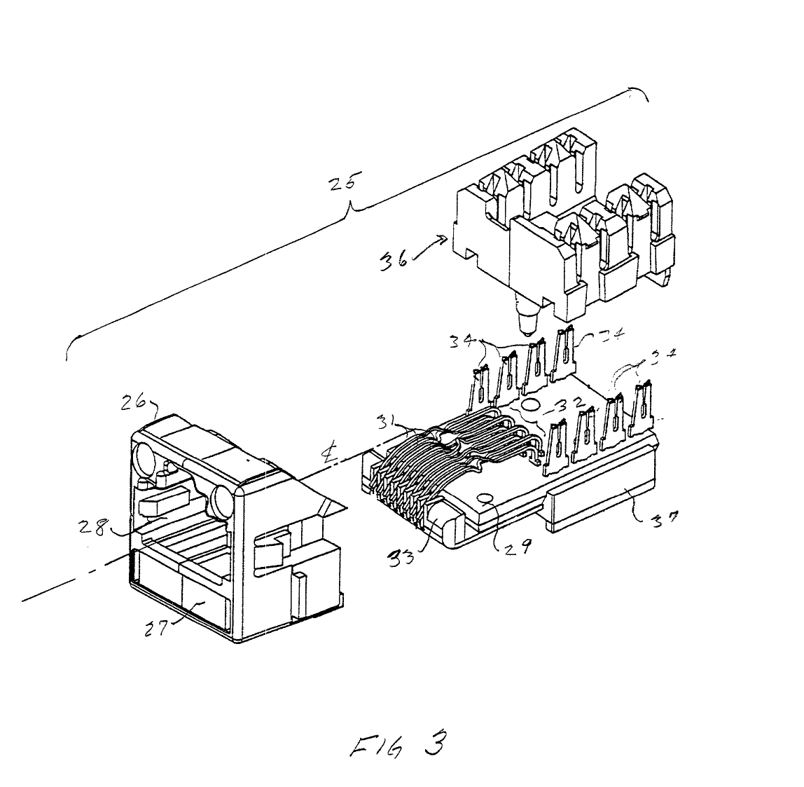

For purposes of the ensuing discussion, and in no way to be considered limiting, plug 14 and jack 16 are configured as an eight contact connector and there is shown, in FIG. 2, the jack contact wiring assignment as specified in ANSI/EIA/TIA-568-1991 which is the Commercial Building Telecommunications Wiring Standard. This standard associates individual wire pairs with specific terminals for an eight position telecommunications outlet.

As discussed hereinbefore, there has been a re-design of the modular jacks to meet ever more demanding electrical performance needs, primarily for accommodating ever increasing bandwidth data communications. Such a re-designed jack 25 is shown in perspective in FIG. 3 and is substantially the same as that disclosed in the aforementioned Goodrich et al. patent. Jack 25 comprises a jack frame or housing 26 having a front face 27 having a plug opening 28, which has a centerline as shown. A generally rectangular printed wiring board (PWB) 29, preferably of non-conducting material, has arrayed thereon a plurality of spring wire contacts 31, shown in FIG. 3 as eight contacts which are attached to the board 29 at a central portion 32 thereof and extend forward in uniformly spaced parallel array. Wires 31 are generally uniform spaced a certain distance above a front portion 33 of board 29 and project downward and forward therefrom as shown, forming an array of spring contacts which are configured to deflect resiliently toward the board 29 when engaged by the mating plug of the connector in a direction parallel to the board 29. Spring wires may be of any one of a number of suitable materials such as, for example, a copper alloy, spring-tempered phosphor bronze, beryllium copper, or the like. A plurality (8) of insulation displacement connector (IDC) 34 are mounted on board 29 and extend upwardly therefrom at either side, as shown. Each of the IDC's 34 is connected to corresponding conductive path (not shown) associated with a different one of the spring wires 31. An electrically insulative or dielectric terminal housing 36 embraces the IDC's 34 and permits the attachment of external wire leads (not shown) thereto. A cover member 37 of suitable dielectric or insulating material is mounted to, and protects the bottom of, board 29. The connector jack 25 as shown in FIG. 3 is generally referred to as a rear cantilevered type jack as opposed to the front cantilevered type which heretofore has been widely used.

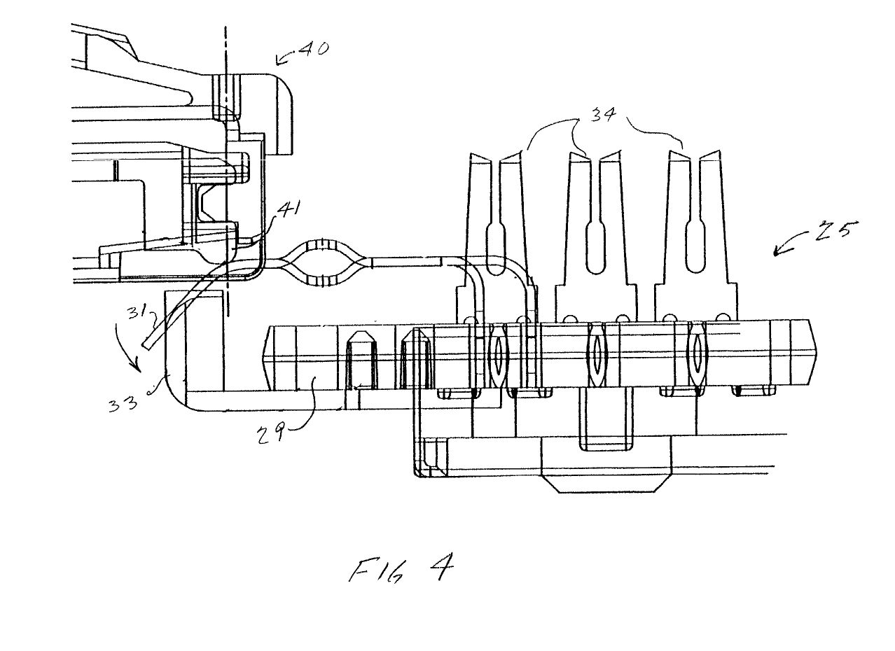

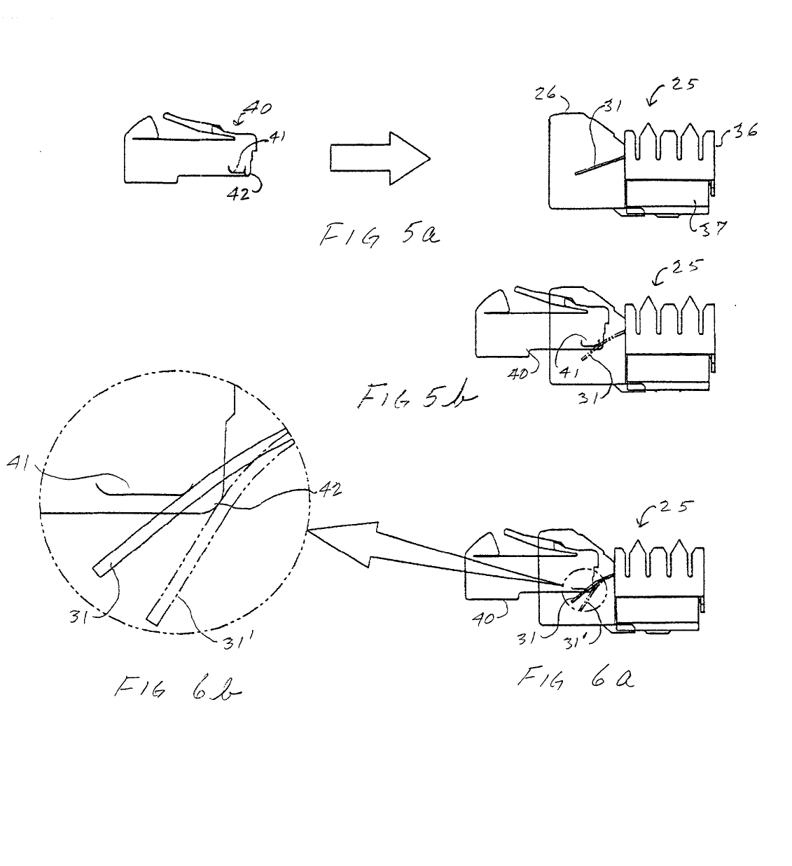

FIG. 4 is a diagrammatic view of the manner in which a conventional connector plug 40 having an array of contact blades 41 connects with the jack 25, more particularly the spring wires 31 when inserted into the jack 25. As can be seen, each of the contact blades 41, which are equally spaced the same distance apart as are the spring wires 31, engages a corresponding spring wire 31 and depresses it in the direction of the arrow. The amount of depression is insufficient to distort or exceed the resilience limits of the wire 31, but is sufficient for the spring wire to maintain contact with the blade. The diagram of FIG. 4 depicts the contact action for an eight contact jack and a corresponding eight contact plug. As can be seen, all of the spring contacts 31 are depressed equally by the contact blades 41 of the plug without distortion or overbending of the contact springs 31, as illustrated in diagrams 5a and 5b. However, when, for example, a six contact plug is introduced into the eight contact jack, the two outermost or end spring contacts (positions 1 and 8 in FIG. 2) are not contacted by the plug blade contacts 41, which lie in slots in the plug, but are, instead, cammed downward or depressed by the nose 42 of the plug 40, and, as insertion of the plug 40 is completed, are bent to a considerably greater angle than are the remaining spring contacts, as shown in diagrammatic views 6a and 6b. As discussed hereinbefore, this overbending of the spring contact, designated 31′, can permanently distort it, or place it in a position where metal fatigue becomes a factor so that it becomes useless, or at least unreliable, in functioning as a contact when, for example, an eight contact plug is subsequently inserted into jack 25.

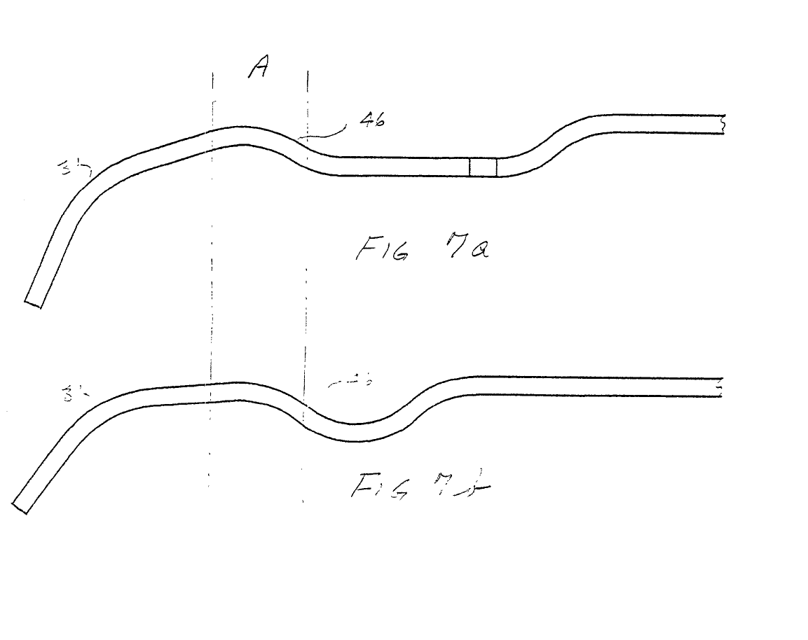

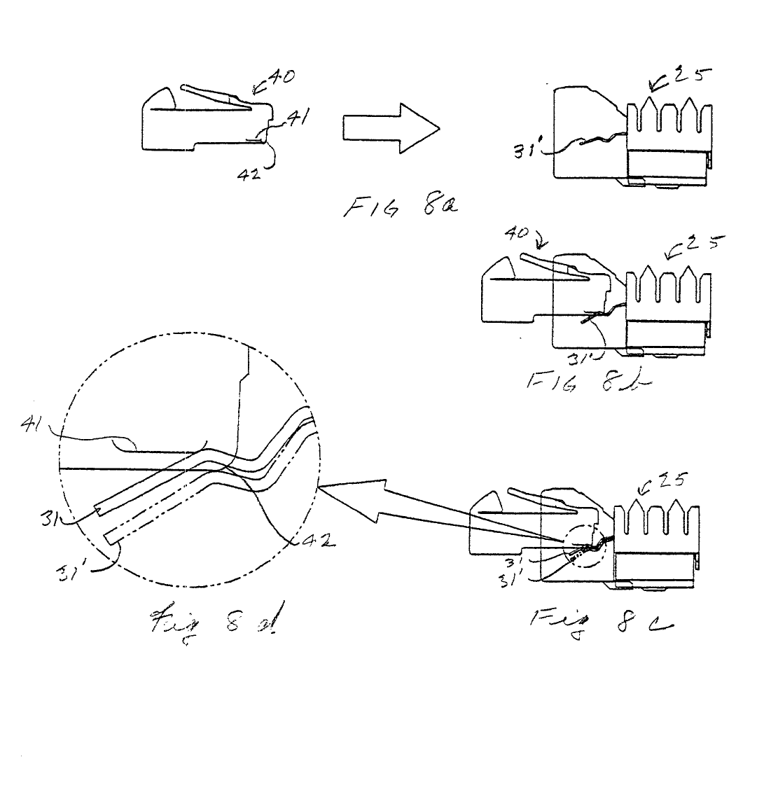

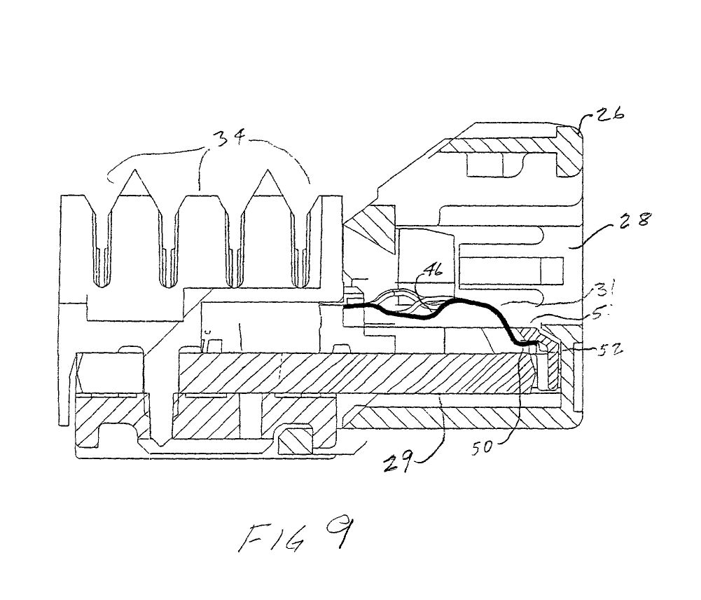

The present invention is aimed at reducing the amount of bend imparted to the spring contact 31′ by the nose 42 of the plug when inserted into jack 25. In FIG. 7a there is shown the forward end of a spring contact 31′ which embodies the invention, and in FIG. 7b is shown an alternative configuration for the forward or contact end of the spring contact, likewise embodying the principles of the invention. As can be seen in these figures, the contact region A is followed by a depression 46 in the spring contact 31′. When a six contact plug is inserted into jack 25, the nose portion 42 of the plug cams or depresses the spring 31′ only until it reaches the depressed region A, within which it ceases to have any further camming effect. In the meantime, the remaining spring contacts 31 make contact with the contact blades 41. The degree of bending of spring contacts 31′ in positions 1 and 8 is thus materially less than that shown in FIGS. 6a and 6b, as is shown in FIGS. 8a and through 8d. Inasmuch as the spring contacts 31 are stamped out in a wire frame (not shown) during manufacture, the operation could be simplified by forming all of the springs in the configuration shown in either FIG. 7a or 7b, inasmuch as that configuration insures contact with the plug blades despite the depressed portion 46 shown. This is, however, simply an alternative not affecting the operation. The spring contact 31′ shown in FIGS. 8a through 8d corresponds to that shown in FIG. 7b which is formed and shaped as an S curve. Inasmuch as the bending of spring contact 31′ is materially lessened, it is not permanently affected thereby and contact 31′ retains its resilience, thereby insuring continuation of its contact action for subsequent plugs of eight contact configuration.

In FIG. 9 there is shown an alternative embodiment of the jack of invention. In this embodiment, wherein like parts to those in previous figures bear the same reference numerals, the spring wires 31 extend downward and forward with their forward ends 50 being in contact with the lower surface 52 of a spring guide 51 and spaced from board 29. The action when a plug is inserted is substantially the same as that in previous embodiments except that the spring wires 31 may contact the non-conducting surface of board 29.

The foregoing discussion has been directed to an eight contact jack and a six or eight contact plug. It is to be understood that the principles of the invention may be extended to use with other members of contacts where the jack has a greater number of spring contacts than does the plug.

It is to be understood further that the various features of the present invention might be incorporated into other types of connectors and that other modifications or adaptations might occur to workers in the art. All such variations or modifications are intended to be included herein as being within the scope of the present invention as set forth. Further, in the claims hereinafter, the corresponding structures, materials, acts and equivalents of all means or step-plus-function elements are intended to include any structure, material, or acts for performing the functions in combination with the other elements as specifically claimed.

1. A connector jack comprising:
a housing having an opening therein for receiving a connector plug;
a board member having a front portion and having arrayed thereon a first plurality of spring wire contacts, said spring wire contacts being mounted at one end to said board and extending toward said front portion in a spaced parallel array, said spring wires being spaced from said board member and having a forward portion projecting downward and forward from the front portion thereof forming an array of substantially parallel deflectable spring contacts adapted to be electrical engaged by a connector plug;
at least two of said spring contacts having a contact region along its length adjacent its forward portion adapted to be contacted by the plug, and a depressed portion extending from said contact region toward said central portion of said board.

2. A connector jack as claimed in claim 1 wherein said depressed portion forms a substantially S-shaped configuration in said forward portion of said spring wire.

3. A connector jack as claimed in claim 1 wherein there are eight parallel spring contacts in said array.

4. A connector jack as claimed in claim 1 wherein said at least two deflectable spring contacts are positioned at the extreme ends of said array.

5. A connector jack as claimed in claim 1 wherein each of said spring contacts in said array thereof has a contact region and a depressed portion immediately adjacent thereto.

6. A connector jack as claimed in claim 1 wherein said first plurality of spring contacts is greater than the number of contacts in the plug to be mated thereto.

7. A connector jack as claimed in claim 1 wherein said spring wire contacts are made of a highly resilient metallic material and said board is made of non-conducting material.

8. A connector jack as claimed in claim 1 wherein the forward ends of said spring wires are in contact with a spring guide member prior to insertion of a plug in said jack.
